(19) United States
(12) Patent Application Publication
(10) Pub. No.: US 2025/0084700 A1
(43) Pub. Date: Mar. 13, 2025

(54) OPEN DESIGN FALL ARREST SYSTEM

(71) Applicant: Tuf-Tug, Inc., St. Louis, MO (US)

(72) Inventor: Josh Rickmon, Dayton, OH (US)

(21) Appl. No.: 18/464,328

(22) Filed: Sep. 11, 2023

(51) Int. Cl. E06C 7/18; A62B 35/00

(52) U.S. Cl. CPC E06C 7/186; A62B 35/005; A62B 35/0068

(57) ABSTRACT

A fall arrest system is provided that can be mounted to a ladder or another climbable structure. The fall arrest system includes a cable that extends from an upper member of the fall arrest system to a lower member of the fall arrest system. To couple the cable to the upper member and the lower member, an upper cable supporting assembly and a lower cable supporting assembly are provided. The upper cable supporting assembly may be visible to the ambient environment, and the lower cable supporting assembly may be partially surrounded by a casing with an opening. Thus, the upper cable supporting assembly and the lower cable supporting assembly may be visually inspected without removing housing components. Moreover, the lower cable supporting assembly may include an attenuator for preferably maintaining a desired tension in the cable.

### FIELD OF THE INVENTION

The present invention relates generally to a fall arrest system that is mountable to a climbable structure. More particularly, the invention relates to a fall arrest system that may be inspected without removing housing components.

### BACKGROUND OF THE INVENTION

In the telecommunications and utility industries, technicians must frequently climb to great heights for installations, maintenance, and the like. When they do so, they typically use “fall arrest systems” to provide protection for the workers in the event of a fall and reduce the risk of injury or death.

Existing fall arrest systems typically include a cable (e.g., a ⅜ inch braided steel cable) anchored to the ladder, tower frame, or utility pole on which the worker is climbing. To use a fall arrest system, the worker may wear a harness that includes a security device coupled to the cable. When a fall event occurs, the security device preferably engages with the cable to prevent the security device from moving down the cable, thereby preventing the worker from falling further. For example, U.S. Pat. No. 5,855,251, incorporated herein by reference, describes an example of a security device.

When properly inspected and maintained, existing fall arrest systems provide a safe and reliable method for preventing injury or death. However, to ensure safety, such systems need to be inspected (e.g., before use, after a fall event occurs, periodically, etc.). To further ensure safety, existing fall arrest systems require proper maintenance (e.g., periodic tensioning of the cable due to movement of the structure).

It is burdensome to inspect and maintain fall arrest systems currently on the market. For example, some components of existing fall arrest systems are surrounded by a housing and are positioned at an upper portion of the system. A worker is required to climb to the upper portion of the fall arrest system to remove one or more of the housing components to inspect or maintain such components. However, when climbing to the upper portion of the fall arrest system to perform an inspection, it may be unsafe to use the fall arrest system because it has not yet been inspected. Accordingly, to perform an inspection, a worker may be required to use a second fall arrest system. Additionally, to remove the housing components to perform maintenance or an inspection, the worker may be required to use tools. However, some installation locations do not provide sufficient space for the use of such tools.

Therefore, a solution is desired whereby one can inspect a fall arrest system without removing housing components and without climbing. The system should allow for visual inspections (e.g., from the ground or via a drone) and should preferably reduce the need for tensioning the cable periodically.

### SUMMARY OF THE INVENTION

This invention provides an easily visible fall arrest system that is mountable to a climbable structure. The fall arrest system includes an upper member, a lower member, and a cable extending between the upper member and the lower member. The cable is coupled to the upper member and the lower member by way of an upper anchor and a lower anchor positioned and located on an upper bracket and a lower bracket, respectively.

The upper bracket and the lower bracket preferably include an “open design” such that the components of the upper bracket and the lower bracket can be viewed from the ground without removing housing components. For example, the upper bracket may include two side wall members, and an opening may be provided between the side wall members. The upper anchor preferably extends across the opening, and the cable may be positioned in the opening between the side wall members. Additionally, the lower bracket may include a casing that only partially surrounds the lower bracket. Thus, workers may inspect the upper anchor and the lower anchor without climbing and without tools.

The lower bracket may include an attenuator that comprises an elastically deformable material (e.g., rubber). The attenuator may be positioned and located adjacent to a T-washer. The T-washer may be slidably coupled to the lower bracket. In addition, the T-washer may be coupled to the lower anchor. As a result, the T-washer may be coupled to the cable by way of the lower anchor.

The attenuator may also be positioned and located adjacent to an upper wall of a casing. When a tension is applied to the cable, the lower anchor preferably applies a force to the T-washer in the direction of the upper wall of the casing. If the applied force is greater than a threshold force, the T-washer preferably slides toward the cable to relieve the tension in the cable. When the T-washer slides towards the cable, the attenuator may be compressed between the T-washer and the casing. However, if the force applied by the tension in the cable is approximately equal to the threshold force, the attenuator preferably maintains its size and shape, thereby preventing the T-washer from moving and relieving tension in the cable. Moreover, if the force applied by the tension in the cable is less than the threshold force, the attenuator may apply an expansion force to the T-washer. When the attenuator applies an expansion force to the T-washer, the T-washer preferably slides away from the cable, thereby increasing the tension in the cable. Accordingly, the attenuator preferably interfaces with the T-washer to increase, decrease, or maintain the tension in the cable. In addition, the threshold force may be selected such that the attenuator preferably maintains a desired tension in the cable.

### BRIEF DESCRIPTION OF THE DRAWINGS

For a better understanding of the present invention, reference may be made to the following accompanying drawings.

FIG. 1 is a perspective view of a fall arrest system coupled to a ladder and constructed according to the teachings hereof.

FIG. 2 is a perspective view of the fall arrest system of FIG. 1.

FIG. 3 is an enlarged view of an upper member of the fall arrest system of FIGS. 1 and 2.

FIG. 4 is an enlarged view of a lower member of the fall arrest system of FIGS. 1 and 2.

FIG. 5 is an enlarged view of the lower member of FIG. 4 with a casing removed to better illustrate the lower member.

### DETAILED DESCRIPTION OF THE INVENTION

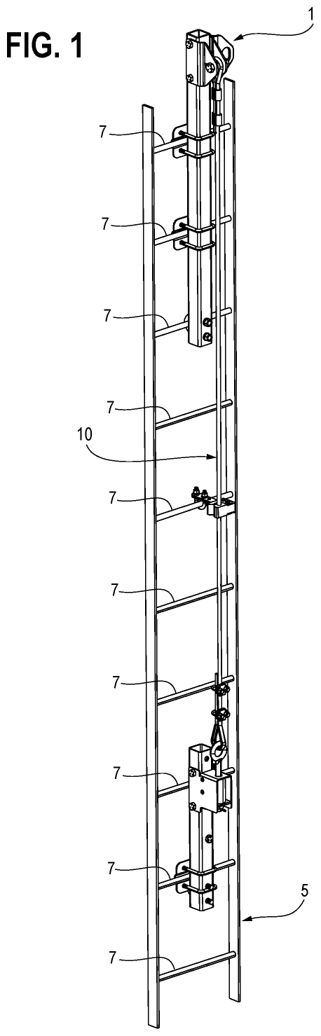

FIG. 1 illustrates a fall arrest system 1 coupled to a ladder 5. The fall arrest system 1 may be coupled to rungs 7 of the ladder 5, although other suitable attachment mechanisms are contemplated. The fall arrest system 1 is designed to secure a worker to the ladder 5 to reduce the risk of injury during fall events. In use, a worker may be attached to a cable 10 of the fall arrest system 1 (e.g., by way of a security device coupled to a harness). In alternative embodiments, the fall arrest system 1 may be mounted to other structures (e.g., a utility pole, a telecommunications tower, a water tower, a wind turbine, a silo, a scaffolding, etc.).

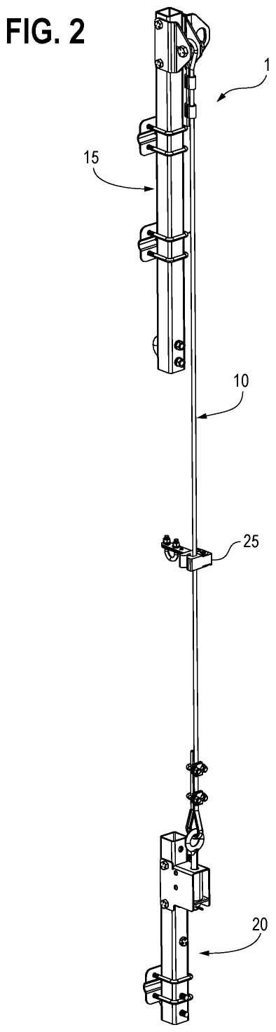

Turning to FIG. 2, the cable 10 may be coupled to an upper member 15 and a lower member 20 of the fall arrest system 1. The upper member 15 and the lower member 20 may be positioned and located on opposing sides of the ladder 5 (see FIG. 1) such that the cable 10 extends along the length of ladder 5. Additionally, the fall arrest system 1 may include a cable guide 25 to preferably prevent or limit movement of the cable 10 relative to the ladder 5. The cable guide 25 may be positioned and located on the cable 10 between the upper member 15 and the lower member 20, and the cable guide 25 may be coupled to the ladder 5. In alternative embodiments, the fall arrest system 1 may include more or fewer cable guides 25.

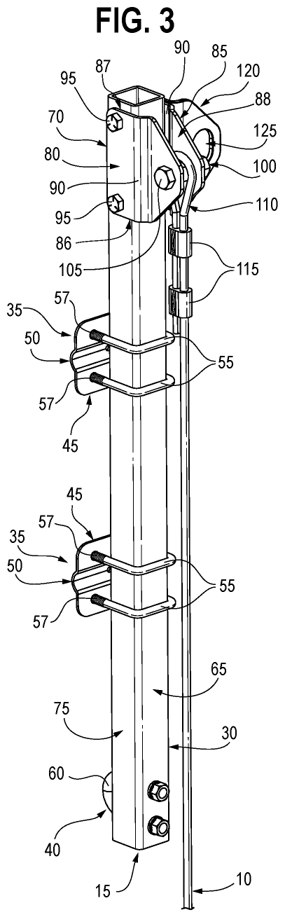

As best illustrated in FIG. 3, the upper member 15 of the fall arrest system 1 may include a first, elongated upright 30 for coupling to the ladder 5. The first upright 30 is provided as a square tube, although other suitable structures (e.g., round tube, angle iron, etc.) are contemplated.

To couple the first upright 30 to the ladder 5, the upper member 15 may include a plurality of attachment means 35 and at least one alternative attachment means 40. The attachment means 35 and the alternative attachment means 40 are designed to selectively engage with the ladder 5 to couple the upper member 15 to the ladder 5. In alternative embodiments, however, the attachment means 35, 40 may be configured to couple with another structure (e.g., a utility pole, a telecommunications tower, a water tower, a wind turbine, a silo, a scaffolding, etc.). The upper member 15 includes two of the attachment means 35 and one of the alternative attachment means 40. However, in alternative embodiments, the fall arrest system 1 may include more or fewer of the attachment means 35, 40.

Each of the attachment means 35 may include a backing plate 45 configured to engage with the ladder 5. More particularly, each of the backing plates 45 may be provided as a substantially flat metal plate with a cavity 50. The cavity 50 is preferably shaped and sized to receive one of the rungs 7 (see, e.g., FIG. 1) of the ladder 5. In some embodiments, the cavity 50 may be a semi-cylindrical pocket, although other suitable shapes (e.g., rectangular, ovoidal, square) for the cavity 50 are foreseeable.

In addition, each of the first attachment means 35 may include two or more square U-bolts 55 for engagement with the backing plate 45 and the first upright 30. The square U-bolts 55 are preferably sized and shaped to surround the first upright 30 and to extend through apertures 57 in the backing plate 45. Thus, the square U-bolts 55 preferably couple the backing plate 45 to the first upright 30. Moreover, the square U-bolts 55 may be positioned and located on opposing sides of the cavity 50. As a result, when a rung 7 is received in the cavity 50, the two or more square U-bolts 55 may abut the rung 7 to preferably retain the rung 7 in the cavity 50.

In contrast to the attachment means 35, the alternative attachment means 40 may include a round U-bolt 60 that extends through a front surface 65 of the first upright 30. The round U-bolt 60 is preferably designed to surround a rung 7 on the ladder 5 to the couple the first upright 30 to the ladder 5. For example, the round U-bolt 60 may include a perimeter (not illustrated) that is substantially the same size and shape as a rung 7. In particular, the perimeter may be substantially circular, although other shapes for the perimeter are foreseeable.

To couple the cable 10 to the upper member 15, an upper bracket 70 may be provided. The upper bracket 70 may be coupled to the upper member 15 on a first side surface 75 and a second side surface (not illustrated) of the first upright 30, although in other embodiments, the upper bracket 70 may be directly coupled to the ladder 5. The first side surface 75 and the second side surface may each be positioned and located adjacent to the front surface 65. In addition, the first side surface 75 and the second side surface may be positioned and located opposite from each other on the first upright 30.

Referring still to FIG. 3, the upper bracket 70 may include a first side wall member 80 and a second side wall member 85 that extend from a first end 86 of the upper bracket 70 to a second end 87 of the upper bracket 70. The side wall members 80, 85 may be positioned and located on the first side surface 75 and the second side surface of the first upright 30, respectively. In addition, the side wall members 80, 85 may be oriented generally parallel to one another and may be spaced apart from one another. As a result, a gap or an opening 88 may be provided in the upper bracket 70 between the side wall members 80, 85.

The side wall members 80, 85 may be provided as metal plates shaped as axial-symmetric pentagons with rounded corners, although other suitable structures are contemplated. In some embodiments, the side wall members 80, 85 may be substantially flat plates. However, the side wall members 80, 85 may optionally include one or more rounded portions 90 where the profile of the side wall members 80, 85 is curved.

The side wall members 80, 85 may be coupled to the first upright 30 by one or more bracket fasteners 95 that extend through the side wall members 80, 85 and through the first upright 30. For example, each of the bracket fasteners 95 may be provided as a bolt with a hexagonal head, although other suitable fasteners are contemplated. Two of the bracket fasteners 95 may be provided, although in other embodiments, more or fewer of the bracket fasteners 95 may be provided.

To couple the cable 10 to the upper bracket 70, the upper bracket 70 may include an upper cable supporting assembly 100. For example, the upper cable supporting assembly 100 may comprise an upper anchor 105 that may be provided as a bolt or another suitable fastener. The upper anchor 105 preferably extends through the side wall members 80, 85 in a generally horizontal direction (i.e., in a direction generally perpendicular to the cable 10 and the length of the ladder 5).

To retain the cable 10 on the upper anchor 105, the upper anchor 105 may extend through an upper loop 110 in the cable 10. The upper loop 110 may be formed by one or more swage sleeves 115 positioned and located on the cable 10. The upper loop 110 is preferably positioned and located on the upper anchor 105 between the side wall members 80, 85. As a result, the cable 10 is preferably retained on the upper bracket 70 in the opening 88 between the side wall members 80, 85. Moreover, due to the shape and the position of the side wall members 80, 85 on the first upright 30, the upper loop 110 and the upper anchor 105 are preferably visible to the surrounding environment. Accordingly, the upper loop 110 and the upper anchor 105 may be inspected without removing any housing components. Thus, the upper bracket 70 may be inspected from the ground (e.g., using binoculars).

In some embodiments, the upper cable supporting assembly 100 may additionally include one or more spacers (not illustrated) positioned and located on the upper anchor 105. The one or more spacers may include a diameter that is larger than a diameter of the upper loop 110. As a result, in alternative embodiments, the one or more spacers preferably interface with the cable 10 to position the upper loop 110 on the upper anchor 105. For example, in some embodiments, the one or more spacers may interface with the upper loop 110 to the position the upper loop 110 approximately equidistant from the side wall members 80, 85.

In addition to coupling the cable 10 to the ladder 5, the upper bracket 70 may include various other features to assist workers in climbing the ladder 5 or other suitable structures (e.g., a utility pole, a telecommunications tower, a water tower, a wind turbine, a silo, a scaffolding, etc.). For example, the upper bracket 70 may include an ancillary plate 120 designed to facilitate “hook climbing.” The ancillary plate 120 may be coupled to one or more of the side wall members 80, 85 of the upper bracket 70, or alternatively, the ancillary plate 120 may be coupled to the first upright 30. An aperture 125 sized and shaped to receive a hook (not illustrated) may extend through the ancillary plate 120. For example, the aperture 125 may comprise a substantially ellipsoidal shape with a major diameter of approximately 1.75 inches and a minor diameter of approximately 1.25 inches, although other shapes and sizes for the aperture 125 are contemplated. To use the ancillary plate 120, a curved hook (not illustrated) may be coupled to a harness (e.g., by a rope), and the curved hook may be extended through the aperture 125. Thus, a curved hook may be extended through the aperture 125 to preferably couple a harness, and thereby a worker, to the upper member 15 without the cable 10.

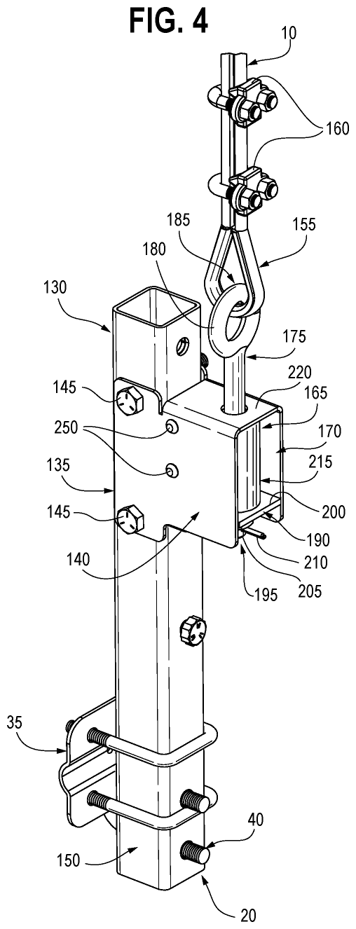

As illustrated in FIG. 4, the lower member 20 of the fall arrest system 1 may comprise a second upright 130. The second upright 130 is provided as a square tube, although other suitable structures (e.g., round tube, angle iron, etc.) for the second upright 130 are contemplated. Similarly to the first upright 30 (see, e.g., FIG. 3), the second upright 130 may be coupled to the ladder 5 (see, e.g., FIG. 1) by at least one of the attachment means 35 and at least one of the alternative attachment means 40. However, in alternative embodiments, the fall arrest system 1 may include more or fewer of the attachment means 35, 40. In yet other embodiments, the attachment means 35, 40 may be alternatively configured to couple with another structure (e.g., a utility pole, a telecommunications tower, a water tower, a wind turbine, a silo, a scaffolding, etc.).

A lower bracket 135 may be positioned and located on the second upright 130 to couple the cable 10 to the lower member 20. The lower bracket 135 may include a casing 140 that preferably shields the lower bracket 135 from the ambient environment. For example, the casing 140 may be provided as a hollow three-dimensional body (e.g., a rectangular prism) that comprises bent sheet-metal, although other suitable structures for the casing 140 are contemplated.

The casing 140 may be coupled to the second upright 130 using one or more casing fasteners 145. For example, each of the casing fasteners 145 may be provided as a bolt with a hexagonal head, although other suitable fasteners are contemplated. Two of the casing fasteners 145 may be provided, although in other embodiments, more or fewer of the casing fasteners 145 may be provided. Each of the casing fasteners 145 may extend through the casing 140 and a first side surface 150 and a second side surface (not illustrated) of the second upright 130. The first side surface 150 and the second side surface may be positioned and located opposite from each other on the second upright 130. In other embodiments, however, the casing fasteners 145 may be alternatively positioned and located on the second upright 130. In yet other embodiments, the casing 140 may be alternatively coupled to the second upright 130 (e.g., via welding).

To couple the cable 10 to the lower bracket 135, the cable 10 may include a lower loop 155. The lower loop 155 may be formed by one or more cable clips 160 positioned on the cable 10 to couple the cable 10 to itself. As a result, the lower loop 155 may have a closed perimeter.

Referring still to FIG. 4, the lower loop 155 of the cable 10 may be coupled to the lower bracket 135 by way of a lower cable supporting assembly 165. The lower cable supporting assembly 165 may be partially surrounded by the casing 140. Thus, the casing 140 preferably shields the lower cable supporting assembly 165 from the ambient environment. However, the casing 140 is also preferably shaped to make it easy to see into the casing 140. For example, an aperture or opening 170 may be provided in the casing 140 adjacent to the lower cable supporting assembly 165. Thus, a user may inspect the lower cable supporting assembly 165 without removing the casing 140.

The lower cable supporting assembly 165 may include a lower anchor 175 designed to receive the lower loop 155 of the cable 10. For example, the lower anchor 175 may be provided as an eye-bolt with an eyelet 180, although other suitable structures for the lower anchor 175 are contemplated. The eyelet 180 may be positioned and located at a proximal end 185 of the lower anchor 175, and the lower loop 155 of the cable 10 may extend through the eyelet 180. Thus, the cable 10 may be coupled to the lower anchor 175 at the proximal end 185 of the lower anchor 175.

The lower anchor 175 may be slidably coupled to the lower member 20 such that the lower anchor 175 may be selectively movable toward or away from the upper member 15 (see, e.g., FIG. 2). Because the cable 10 is coupled to the upper member 15 and the lower anchor 175, movement of the lower anchor 175 preferably increases or decreases the tension in the cable 10. For example, if the lower anchor 175 moves toward the upper member 15, the distance between the upper member 15 and the lower anchor 175 preferably decreases, thereby decreasing the tension in the cable 10. In contrast, if the lower anchor 175 moves away from the upper member 15, the distance between the upper member 15 and the lower anchor 175 preferably increases, thereby increasing the tension in the cable 10.

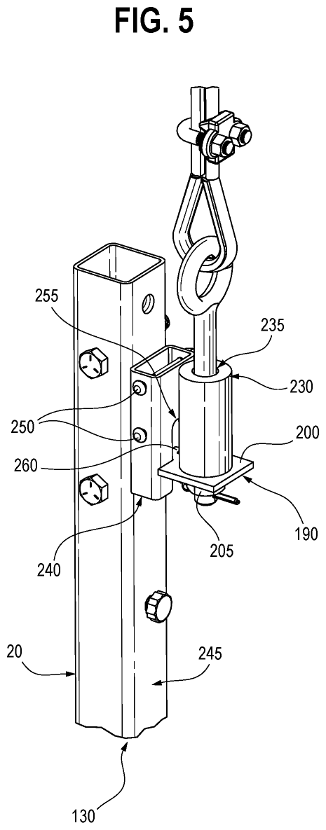

To slidably couple the lower anchor 175 to the lower member 20, the lower anchor 175 may be coupled to a T-washer 190 proximate to a distal end 195 of the lower anchor 175. The T-washer 190 may be a substantially flat plate, and the lower anchor 175 may extend through an aperture (not illustrated) in a main portion 200 of the T-washer 190. The main portion 200 of the T-washer 190 may be substantially rectangular, although other suitable shapes (e.g., circular) are foreseeable. As will be described in connection with FIG. 5, the T-washer 190 may be slidably coupled to the lower member 20. In addition, a nut 205 may be positioned and located on the lower anchor 175 adjacent to the main portion 200 of the T-washer 190. The diameter of the nut 205 may be larger than the aperture in T-washer 190. Thus, the nut 205 is preferably prevented from passing through the T-washer 190, and the nut 205 preferably moves with the T-washer 190.

In addition, a cotter pin 210 may extend through the lower anchor 175 proximate to the distal end 195 of the lower anchor 175. The cotter pin 210 is preferably positioned and located on the lower anchor 175 adjacent to the nut 205. As such, the nut 205 may be positioned in between the cotter pin 210 and the T-washer 190. To retain the nut 205 on the lower anchor 175, the cotter pin 210 may include a length that is preferably larger than a diameter of the nut 205. Accordingly, the cotter pin 210 preferably prevents the nut 205 from moving relative to the lower anchor 175. Thus, the cotter pin 210 and the nut 205 preferably couple the lower anchor 175 and the T-washer 190 such that the lower anchor 175 and the T-washer 190 preferably move together.

To control the movement of the T-washer 190 and the lower anchor 175, an attenuator 215 may be positioned and located concentrically on the lower anchor 175. The attenuator 215 may be positioned and located adjacent to the T-washer 190 and adjacent to an upper wall 220 of the casing 140. The attenuator 215 may be made of an elastically deformable material (e.g., rubber) and may be a substantially cylindrical member including an outer diameter 230 and an inner diameter 235. However, in other embodiments, the attenuator 215 may comprise other suitable structures (e.g., a spring). The outer diameter 230 may be larger than an aperture (not illustrated) in the upper wall 220 of the casing 140 and larger than the aperture in the T-washer 190. For example, the outer diameter 230 may be approximately 1.5 inches, and the inner diameter 235 may be approximately 0.75 inches, although in alternative embodiments, the attenuator 215 may be alternatively shaped or sized. As a result, the attenuator 215 may be retained between the T-washer 190 and the upper wall 220 of the casing 140.

Because the lower anchor 175 is coupled to the T-washer 190, the T-washer 190 is preferably pulled upward (i.e., toward the upper member 15) when a tension is applied to the cable 10. Moreover, because the attenuator 215 is retained between the T-washer 190 and the upper wall 220 of the casing 140, the T-washer 190 preferably applies an upward force to the attenuator 215 as the T-washer 190 is pulled upward by the cable 10.

When the tension applied to the cable 10 exceeds a threshold tension, the force applied to the attenuator 215 may be greater than a threshold force. When the force applied to the attenuator 215 is greater than the threshold force, the attenuator 215 is preferably compressed between the upper wall 220 of the casing 140 and the T-washer 190. Thus, when a tension greater than a threshold tension is applied to the cable 10, the attenuator 215 preferably deforms elastically to allow the T-washer 190 to translate upward toward the cable 10. As the T-washer 190 translates upward toward the cable 10, the lower anchor 175 preferably translates with the T-washer 190 toward the cable 10. Accordingly, when a tension greater than the threshold tension is applied to the cable 10, the attenuator 215 allows the lower anchor 175 to translate upward to reduce the tension in the cable 10.

When the tension applied to the cable 10 is approximately equal to the threshold tension, the force applied by the T-washer 190 is approximately equal to the threshold force. When the force applied to the attenuator 215 is approximately equal to the threshold force, the attenuator 215 preferably maintains it's size and shape. Accordingly, when a force that is approximately equal to the threshold force is applied to the attenuator 215, the attenuator 215 preferably prevents the T-washer 190 from translating upward toward the cable 10. Thus, when a tension approximately equal to the threshold tension is applied to the cable 10, the attenuator 215 preferably prevents the lower anchor 175 from moving upward to reduce the tension in the cable 10. As a result, the attenuator 215 may maintain a tension in the cable 10 that is approximately equal to the threshold tension.

When the attenuator 215 is compressed between the T-washer 190 and the upper wall 220 of the casing 140, the elastic material of the attenuator 215 may create an expansion force in the attenuator 215. The expansion force is preferably applied to the T-washer 190 and the upper wall 220 in outward directions from the attenuator 215. Accordingly, when the attenuator 215 is compressed between the T-washer 190 and the upper wall 220, the attenuator 215 preferably applies the expansion force to the T-washer 190 in a downward direction. In some embodiments, the expansion force may be approximately equal to the threshold force. Therefore, when the force applied by the T-washer 190 is less than the threshold force, the expansion force applied by the attenuator 215 may be greater than the force applied by the T-washer 190. When the force applied by the attenuator 215 is greater than the force applied by the T-washer 190, the attenuator 215 may expand. As the attenuator 215 expands, the T-washer 190 is preferably pushed downward by the attenuator 215. Accordingly, the lower anchor 175 may move away from the cable 10, and the tension in the cable 10 may increase. Thus, the attenuator 215 may increase the tension in the cable 10 when the tension in the cable 10 is less than the threshold tension.

As best illustrated in FIG. 5, the T-washer 190 may be slidably coupled to the lower member 20 by way of a frame 240. The frame 240 may be hollow three-dimensional body (e.g., a rectangular prism) formed from sheet metal, although other suitable structures for the frame 240 are contemplated. The frame 240 may be positioned and located on a front surface 245 of the second upright 130. The frame 240 may be coupled to the casing 140 by two or more frame fasteners 250 (see also FIG. 4) extending through the casing 140 and through the frame 240. In alternative embodiments, however, the frame 240 may be coupled to the lower member 20 using other suitable means. For example, in some embodiments, the frame fasteners 250 may extend through the second upright 130. In other embodiments, the frame 240 may be welded to the second upright 130.

To couple the T-washer 190 to the frame 240, the frame 240 may include a channel 255. The channel 255 may be a substantially rectangular aperture with rounded edges, although other suitable shapes for the channel 255 are foreseeable. In some embodiments, the channel 255 may extend along the frame 240 in a substantially vertical direction (i.e., in a direction parallel to the cable 10 and to the length of the ladder 5).

To couple the T-washer 190 to the channel 255, the T-washer 190 may include a tab portion 260. The tab portion 260 may be a flat protrusion extending outward from the main portion 200. The tab portion 260 may be sized and shaped to be received in the channel 255 of the frame 240. As a result, the T-washer 190 may be coupled to the frame 240, and the T-washer 190 may be vertically movable relative to the frame 240.

In some embodiments, the fall arrest system 1 may inhibit the components of the fall arrest system 1 from corroding or deteriorating. For example, some or all of the components of the upper member 15 and/or the lower member 20 may comprise a hot-dipped galvanized coating. In other embodiments, some or all of the components of the upper member 15 and/or the lower member 20 may be made of stainless steel. Moreover, in some embodiments, some or all of the components of the upper member 15 and/or the lower member 20 may be painted to provide corrosion resistance. In some such embodiments, the paint system may be a safety yellow paint system.

From the foregoing, it will be seen that the various embodiments of the present invention are well adapted to attain all the objectives and advantages hereinabove set forth together with still other advantages which are obvious, and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

Many changes, modifications, variations, and other uses and applications of the present invention will, however, become apparent to those skilled in the art after considering the specification and the accompanying drawings. All such changes, modifications, variations, and other uses and applications which do not depart from the spirit and scope of the invention are deemed to be covered by the invention, which is limited only by the claims which follow.

1. A fall arrest system for a climbable structure, the fall arrest system comprising:
an upper member affixed to an upper portion of the climbable structure;
an upper anchor positioned and located on the upper member;
a lower member affixed to a lower portion of the climbable structure;
a lower anchor positioned and located on the lower member;
a cable coupled at a first end to the upper anchor and at a second end to the lower anchor;
an attenuator positioned and located on the lower member, the attenuator including an elastically deformable material; and
wherein the attenuator is deformed when a tension greater than a threshold tension is applied to the cable.

2. The fall arrest system according to claim 1, wherein the lower anchor extends through the attenuator.

3. The fall arrest system according to claim 1, wherein the lower anchor is slidably coupled to the lower member.

4. The fall arrest system according to claim 1, further including:
a T-washer coupled to the lower anchor; and
wherein the T-washer is slidably coupled to the lower member such that the T-washer is movable in a direction parallel to the cable.

5. The fall arrest system according to claim 1, further including a casing positioned and located on the lower member, wherein the casing partially surrounds the attenuator.

6. The fall arrest system according to claim 1, wherein:
the lower anchor includes an eye-bolt having a closed perimeter;
the upper anchor includes a bolt having a shaft;
a lower loop of the cable extends through the closed perimeter of the lower anchor; and
an upper loop of the cable is received by the shaft of the upper anchor.

7. The fall arrest system according to claim 1, further including:
a first side wall member and a second side wall member positioned and located on the upper member opposite from one another;
an opening positioned and located between the first side wall member and the second side wall member;
wherein the opening extends through the upper member; and
wherein the upper anchor extends across the opening.

8. A fall arrest system configured to couple with a climbable structure, the fall arrest system comprising:
a lower member affixed to a lower portion of the climbable structure;
a lower bracket positioned and located on the lower member;
an upper member affixed to an upper portion of the climbable structure;
an upper bracket positioned and located on the upper member, the upper bracket extending from a first end to a second end;
a cable including a lower loop and an upper loop;
wherein the lower loop of the cable is coupled to the lower bracket;
wherein the upper bracket includes at least two side wall members extending from the first end of the upper bracket to the second end of the upper bracket;
wherein the upper loop of the cable is positioned and located between the first end and the second end of the upper bracket; and
wherein the upper loop of the cable is positioned and located between the at least two side wall members.

9. The fall arrest system of claim 8, wherein the lower bracket includes an attenuator that deforms in response to a tension in the cable.

10. The fall arrest system of claim 8, further including an upper anchor extending between the at least two side wall members, and wherein the upper loop of the cable is positioned and located on the upper anchor.

11. The fall arrest system of claim 8, wherein each of the at least two side wall members includes a plate having a pentagonal shape.

12. The fall arrest system of claim 8, wherein the upper member and the lower member each include an upright provided as a tubular member, and wherein each of the uprights are configured to selectively couple with the climbable structure.

13. The fall arrest system of claim 8, wherein the upper bracket further includes an ancillary plate sized and shaped to receive a climbing hook.

14. A fall arrest system configured to couple with a climbable structure, the fall arrest system comprising:
an upper bracket positioned and located proximate to an upper end of the climbable structure, the upper bracket including a first side wall member and a second side wall member positioned and located on opposite sides of the upper bracket;
an opening extending through the upper bracket, the opening positioned and located between the first side wall member and the second side wall member;
an upper anchor extending through the first side wall member and the second side wall member;
a lower bracket positioned and located proximate to a lower end of the climbable structure, the lower bracket including:
a frame;
a T-washer slidably coupled to the frame;
a lower anchor coupled to the T-washer;
an attenuator positioned and located on the lower anchor;
a cable including an upper loop and a lower loop; and
wherein the upper loop of the cable is coupled to the upper anchor, the lower loop of the cable is coupled to the lower anchor, and the attenuator is deformed when a tension is applied to the cable.

15. The fall arrest system according to claim 14, further including a casing coupled to the frame, the casing at least partially surrounding at least one of the T-washer and the frame, and the casing including an aperture positioned and located on a front side of the casing.

16. The fall arrest system according to claim 14, wherein:
the lower bracket further includes a casing coupled to the frame;
the attenuator is positioned and located adjacent to the casing and adjacent to the T-washer; and
the attenuator is compressed between the casing and the T-washer when the tension is applied to the cable.

17. The fall arrest system according to claim 14, wherein the climbable structure is at least one of a ladder, a utility pole, a telecommunications tower, a water tower, a wind turbine, a silo, and a scaffolding.

18. The fall arrest system according to claim 14, wherein at least one of the upper bracket and the lower bracket includes a hot-dipped galvanized coating.

19. The fall arrest system according to claim 14, wherein the attenuator includes a substantially cylindrical member having an outer diameter and an inner diameter, and wherein the inner diameter is larger than a diameter of the lower anchor.

20. The fall arrest system according to claim 14, wherein the first side wall member and the second side wall member each include a metal plate with a rounded portion, and the upper loop is positioned and located between the first side wall member and the second side wall member.
